(19) United States
(12) Patent Application Publication
(10) Pub. No.: US 2014/0042180 A1
(43) Pub. Date: Feb. 13, 2014

(54) ADJUSTING APPARATUS FOR RELEASE MEMBER

(71) Applicants: HONG FU JIN PRECISION INDUSTRY (WUHAN) CO., LTD, Wuhan (CN); HON HAI PRECISION INDUSTRY CO., LTD., New Taipei (TW)

(72) Inventors: YUN-LUNG CHEN, New Taipei (TW); CHUNG CHAI, New Taipei (TW); DA-LONG SUN, Wuhan (CN); LI TONG, Wuhan (CN); XI-FENG WU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/891,158

(22) Filed: May 9, 2013

(30) Foreign Application Priority Data
Aug. 7, 2012 (CN) 2012102780206

(51) Int. Cl. G07F 11/38

(52) U.S. Cl. CPC G07F 11/38
USPC 221/277

(57) ABSTRACT

An apparatus for adjusting the starting position of circular movement includes a driver, a connected slave shaft, a system command returning module, a touching block, and an adjusting member. A release member is secured to the slave shaft, and the slave shaft is rotatable. The touching block surrounds the slave shaft and includes a cam with a touching surface, and abuts the system command returning module. The driver stops rotating the slave shaft and the release member when the touching surface abuts the system command returning module. The adjusting member relative to the touching block has a fixed position and an unfixed position. In the fixed position, the touching block is engaged with the slave shaft. In the unfixed position, the touching block is rotatable relative to the slave shaft for adjustment purposes.

### BACKGROUND

1. Technical Field

The present disclosure relates to electronic devices, and more particularly to an apparatus for adjusting the starting position of a release member in a vending machine.

2. Description of Related Art

Vending machines typically include a delivery tray, and the delivery tray includes a plurality of separated plates. A plurality of passages is defined between the separated plates for the merchandise to pass through. A release member is located in each of the plurality of passages. When the customer purchases the merchandise from the vending machine, a driver moves the release member to push the merchandise out of the passage. The original position of the release member may need adjustment to ensure the merchandise drops to a suitable location. However, when adjusting the position of the release member, the release member, the driver, and the plurality of separated plates need to be detached from the delivery tray, which is inconvenient. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an adjusting apparatus and a delivery tray in accordance with an embodiment.

FIG. 2 is similar to FIG. 1, but viewed from a different aspect.

FIG. 3 is an assembled view of the adjusting member of FIG. 2.

FIG. 4 is a cross-sectional view of FIG. 3, taken along IV-IV, but only showing a part of the release member.

FIG. 5 is an assembled view of the items in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

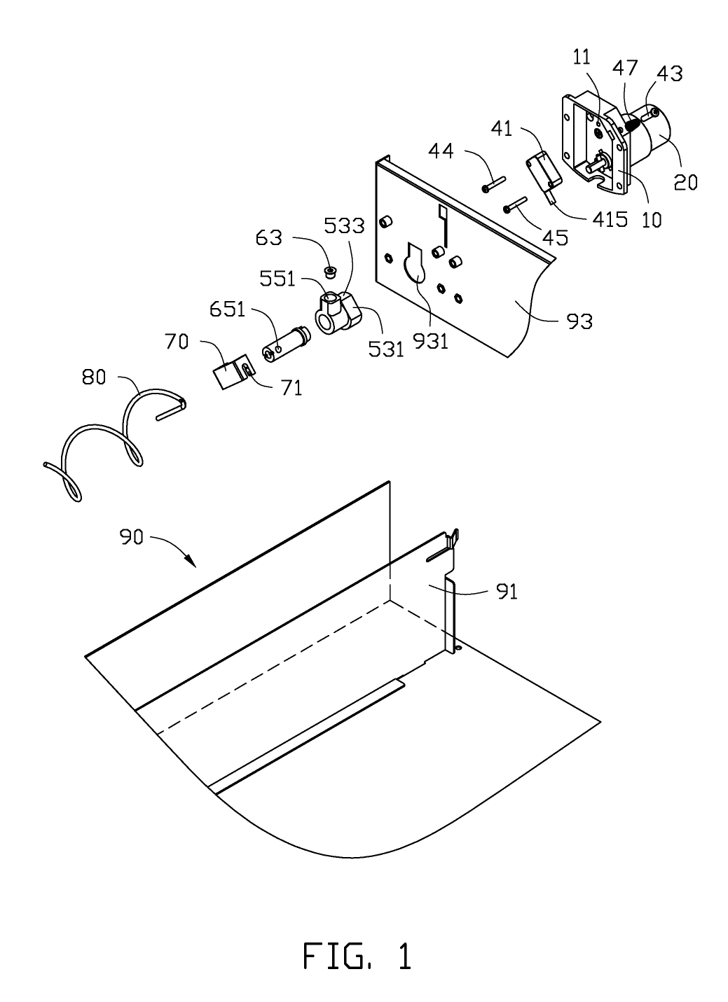

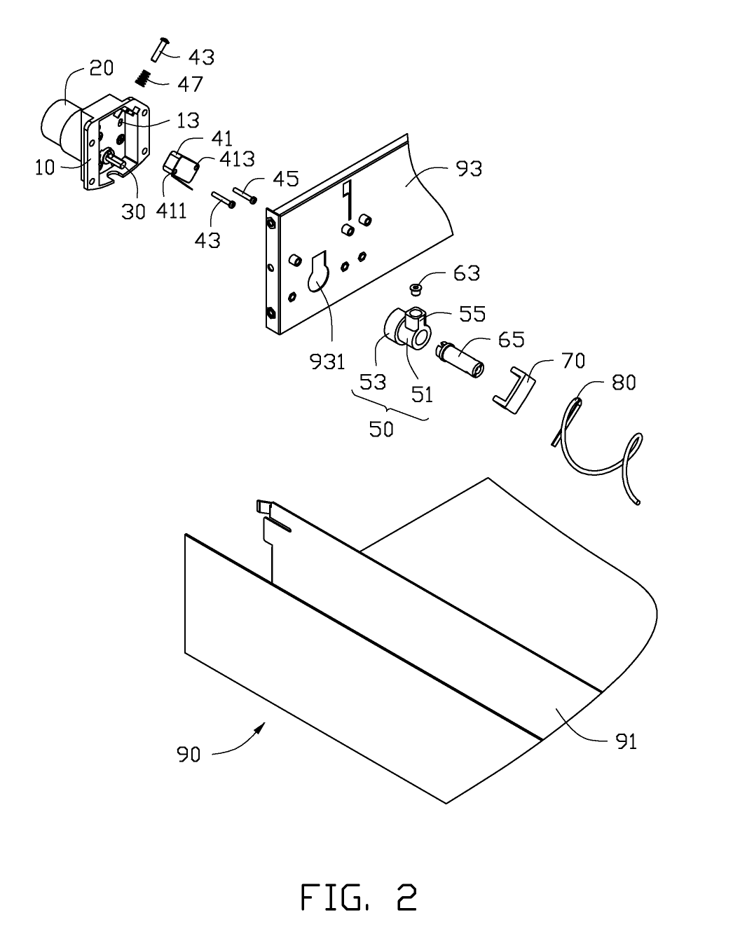

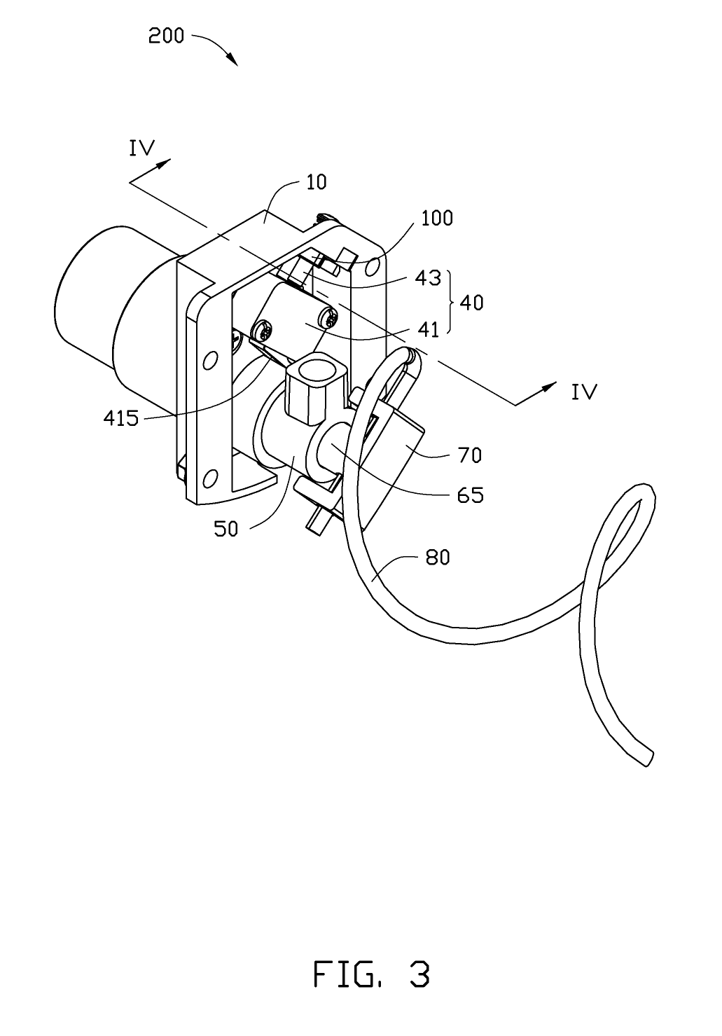

FIGS. 1 and 2 illustrate an embodiment of an adjusting apparatus 200 (only shown in FIG. 3) of a vending machine (not shown). The adjusting apparatus 200 is secured to a delivery tray 90 and includes a mounting box 10, a driver 20 secured to the mounting box 10, a drive shaft 30, a system command returning module 40, a touching block 50, a slave shaft 65, an adjusting member 63, and a clipping member 70. In one embodiment, the driver 20 is a motor, and the adjusting member 63 is a screw. The slave shaft 65 is detachably secured to the drive shaft 30 by meshing and defines a clipping hole 651 positioned in one end of the slave shaft 65.

The mounting box 10 defines a mounting hole 11 and a sliding slot 13 adjacent to the mounting hole 11.

The system command returning module 40 includes a sensor switch 41 engaged with the touching block 50, and a resisting member 43 engaged with the sensor switch 41. The sensor switch 41 defines a first receiving hole 411 and a second receiving hole 413. In one embodiment, the sensor switch 41 is rectangular, and the first receiving hole 411 and the second receiving hole 413 are arranged respectively in the diagonal corners in the switch 41. A sensor portion 415 is secured to the sensor switch 41 for engaging with the touching block 50. A resilient member 47 surrounds the resisting member 43.

The touching block 50 includes a sleeve portion 51 and a cam 53. The sleeve portion 51 sleeves on the slave shaft 65. A securing post 55 is located on a surface of the sleeve portion 51 and a securing hole 551 is defined therein, extending to the sleeve portion 51 for receiving the adjusting member 63. The cam 53 includes a touching surface 531 and an arcuate surface 533 connected to the touching surface 531. In one embodiment, the touching surface 531 is substantially slanted.

The clipping member 70 secures a release member 80, and a receiving slot 71 is defined in the clipping member 70. In one embodiment, the clipping member 70 is substantially U-shaped, and the release member 80 is a spring.

The delivery tray 90 includes a plurality of separated plates 91 and a rear plate 93 connected to the plurality of separated plates 91. A through hole 931 is defined in the rear plate 93.

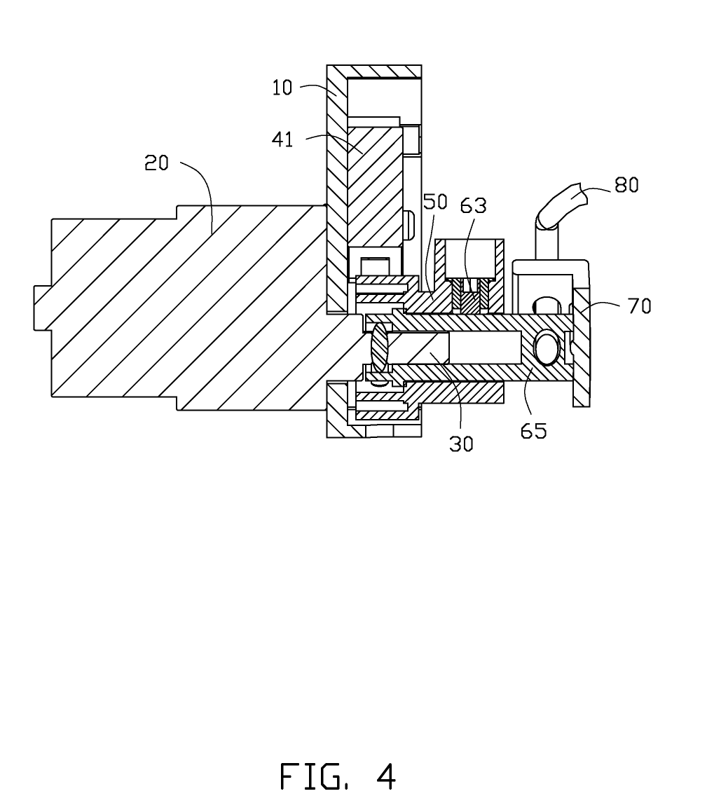

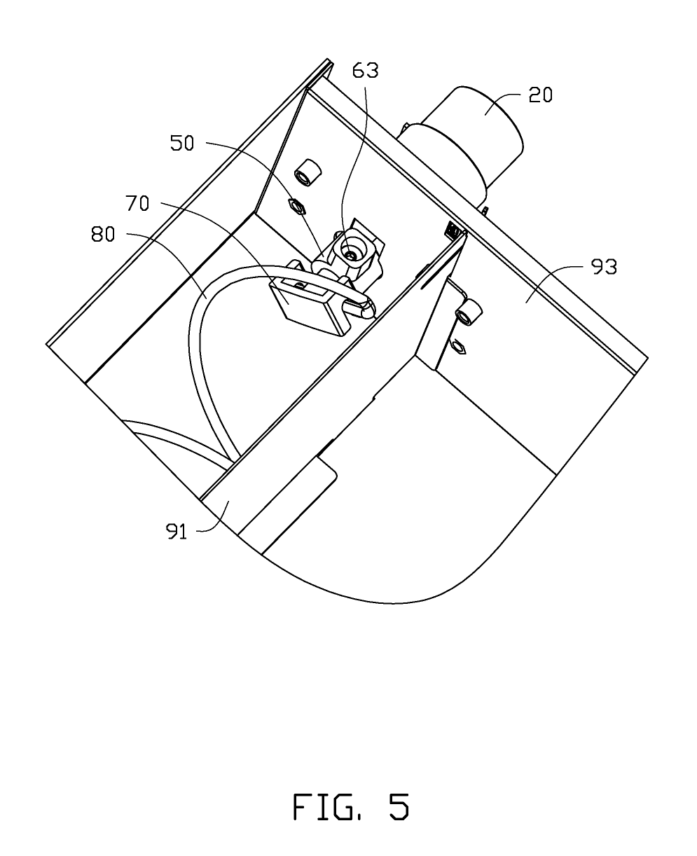

FIGS. 3-5 illustrate the assembly of the adjusting apparatus and the delivery tray 90 in accordance with an embodiment. In assembly, a first shaft 44 is engaged in the first receiving hole 411 and the mounting hole 11, to rotatably secure the sensor switch 41 to the mounting box 10. A second shaft 45 extends through the second receiving hole 413 and is slidably received in the sliding slot 13. The resilient member 47 surrounds the resisting member 43. The resisting member 47 is slanted relative to the mounting box 10 and extends through the mounting box 10, to abut the sensor switch 41. A fixing member 100 is engaged with the resisting member 43 to prevent the resisting member 43 from disengaging from the mounting box 10. A first end of the resilient member 47 is secured to the mounting box 10. A second end of the resilient member 47 is secured to a head of the resisting member 43. The system command returning module 40 is thereby secured to the mounting box 10.

The slave shaft 65 is engaged with the drive shaft 30, and the clipping hole 651 is exposed outside of the mounting box 10. The sleeve portion 51 of the touching block 50 sleeves on the slave shaft 65, and the touching block 50 is below the system command returning module 40. The adjusting member 63 is locked into the securing hole 551, to engage the touching block 50 with the slave shaft 65.

The mounting box 10 is located outside of the rear plate 93, and the drive shaft 30 extends through the through hole 931. The mounting box 10 is secured to the rear plate 93 by means well known in the art, such as by screws. The clipping member 70 is placed on the slave shaft 65, and the receiving slot 71 is aligned with the securing hole 531. The release member 80 is located between every two adjacent separated plates 91. An end of the release member 80 extends through the receiving slot 71 and the clipping hole 651, to secure the release member 80 to the slave shaft 65 and the clipping member 70.

In use, a rotation command from a control unit of the vending machine is sent to the driver 20. The driver 20 starts to rotate the drive shaft 30. The drive shaft 30 rotates the slave shaft 65 and the release member 80, so that the merchandise item separates and drops from the release member 80. When the drive shaft 30 is rotated and the arcuate surface 513 abuts the sensor portion 415, the sensor switch 41 is rotated around the first shaft 44 in a first direction, and the second shaft 45 is slid in the sliding slot 13. Simultaneously, the sensor switch 41 urges the resisting member 43 to deform the resilient member 47. When the arcuate surface 533 has passed the sensor switch 41 and the touching surface 531 abuts the sensor portion 415, the sensor switch 41 is rotated around the first shaft 44 in a second direction opposite to the first direction. The second shaft 45 is slid in the sliding slot 13. The resilient member 47 is released. The sensor portion 415 will then sense that the drive shaft 30 has been rotated in a complete circle and send a stop signal to the system of the vending machine.

When an original position of the release member 80 needs to be adjusted, the adjusting member 63 is detached from the slave shaft 65. The touching block 65 can then be rotated relative to the slave shaft 65 to adjust a position of the touching surface 531 relative to the sensor portion 415, thus precisely adjusting the starting position of the release member 80 for the next purchase.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An adjusting apparatus comprising:
a driver;
a slave shaft connected to the driver;
a release member secured to the slave shaft, the slave shaft being rotatable to rotate the release member;
a system command returning module;
a touching block surrounding on the slave shaft and comprising a touching surface; and
an adjusting member connected to the slave shaft,
wherein the adjusting member rotates from a fixed position to an unfixed position relative to the touching block; the touching block is engaged with the slave shaft in the fixed position; the touching block is rotatable relative to the slave shaft in the unfixed position; and the driver stops rotating the slave shaft and the release member when the touching surface abuts the system command returning module.

2. The adjusting apparatus of claim 1, further comprising a clipping member, wherein the clipping member defines a receiving slot, the slave shaft defines a clipping hole, and the receiving slot is aligned with the clipping hole to receive the release member.

3. The adjusting apparatus of claim 1, wherein the touching block comprises a sleeve portion, and the sleeve portion sleeves on the slave shaft.

4. The adjusting apparatus of claim 3, wherein the touching block further comprises a securing post located on the sleeve portion, and the securing post defines a securing hole extending to the sleeve portion to receive the adjusting member.

5. The adjusting apparatus of claim 3, wherein the touching block further comprises a cam extending from the sleeve portion, the cam comprises an arcuate surface and the touching surface is connected to the arcuate surface, and the driver rotates the slave shaft when the system command returning module abuts the arcuate surface.

6. The adjusting apparatus of claim 1, further comprising a mounting box secured to a delivery tray, wherein the driver is attached to the mounting box, the system command returning module comprises a sensor switch, and the sensor switch is moveably secured to the mounting box.

7. The adjusting apparatus of claim 6, wherein the system command returning module further comprises a resisting member and a resilient member; the resisting member is engaged in the mounting box and abuts the sensor switch, and the resilient member surrounds on the resisting member.

8. The adjusting apparatus of claim 6, wherein the mounting box defines a sliding slot;
the sensor switch comprises a first shaft and a second shaft; the sensor switch is rotatably secured to the mounting box by the first shaft; and the drive shaft rotates the sensor switch around the first shaft, so that the second shaft is slidable in the sliding slot.

9. The adjusting apparatus of claim 1, further comprising a drive shaft attached to the driver, and the slave shaft is meshed with the drive shaft.

10. An adjusting apparatus comprising:
a rear plate;
a driver attached to the rear plate;
a slave shaft connected to the driver and located inside of the rear plate;
a release member secured to the slave shaft, the slave shaft being rotatable to rotate the release member driven by the driver;
a system command returning module;
a touching block surrounding on the slave shaft and comprising a touching surface, the touching block abutting the system command returning module; and
an adjusting member fixed in the touching block to engage the touching block with the slave shaft,
wherein the touching block is rotatable relative to the slave shaft to adjust a position of the touching surface relative to the system command returning module when the adjusting member is unfixed; and the driver stops rotating the slave shaft and the release member when the touching surface abuts the system command returning module.

11. The adjusting apparatus of claim 10, wherein the rear plate defines a through hole, and the slave shaft extends into through hole.

12. The adjusting apparatus of claim 10, further comprising a clipping member, wherein the clipping member defines a receiving slot, the slave shaft defines a clipping hole, and the receiving slot is aligned with the clipping hole to receive the release member.

13. The adjusting apparatus of claim 10, wherein the touching block comprises a sleeve portion, and the sleeve portion sleeves on the slave shaft.

14. The adjusting apparatus of claim 13, wherein the touching block further comprises a securing post located on the sleeve portion, and the securing post defines a securing hole extending to the sleeve portion to receive the adjusting member.

15. The adjusting apparatus of claim 13, wherein the touching block further comprises a cam extending from the sleeve portion, the cam comprises an arcuate surface and the touching surface is connected to the arcuate surface, and the driver rotates the slave shaft when the system command returning module abuts the arcuate surface.

16. The adjusting apparatus of claim 10, further comprising a mounting box secured to a delivery tray, wherein the driver is attached to the mounting box, the system command returning module comprises a sensor switch, and the sensor switch is moveably secured to the mounting box.

17. The adjusting apparatus of claim 16, wherein the system command returning module further comprises a resisting member and a resilient member; the resisting member is engaged in the mounting box and abuts the sensor switch, and the resilient member surrounds on the resisting member.

18. The adjusting apparatus of claim 16, wherein the mounting box defines a sliding slot;
the sensor switch comprises a first shaft and a second shaft; the sensor switch is rotatably secured to the mounting box by the first shaft; and the drive shaft rotates the sensor switch around the first shaft, so that the second shaft is slidable in the sliding slot.

19. The adjusting apparatus of claim 10, further comprising a drive shaft attached to the driver, and the slave shaft is meshed with the drive shaft.
